(19) United States
(12) Patent Application Publication
(10) Pub. No.: US 2006/0175350 A1
(43) Pub. Date: Aug. 10, 2006

(54) Multi-compartment container

(76) Inventor: Andrew F. Abramson, Boston, MA (US)

Correspondence Address: Andrew F. Abramson, 33 Concord Square, Boston, MA, 02118, US

(21) Appl. No.: 11/054,105

(22) Filed: Feb. 9, 2005

(51) Int. Cl. B67D 5/56

(52) U.S. Cl. 222/129

(57) ABSTRACT

The invention includes a container and method for dispensing a single liquid out of the container that can store more than one liquid. The container includes a first compartment to store a first liquid and a second compartment to store a second liquid. The container also includes an opening and a rotatable piece having a liquid release opening. The container additionally includes a control connected to the rotatable piece enabling the first liquid or the second liquid to be dispensed from the opening of the container by rotating the rotatable piece so that the liquid release opening aligns with one of the first compartment and the second compartment.

### FIELD OF THE INVENTION

The invention relates to containers, and, more particularly, relates to a container that can store one or more liquids simultaneously while enabling the dispensing of only one liquid at a time.

### BACKGROUND

Containers capable of storing a liquid are commonplace. For example, jars, cans, cups, and bottles are a few of the containers having a single volume used to store liquid. Few containers, however, have been designed or sold that enable the storage of more than one liquid at a time (without mixture of the liquids).

The problem often arises with respect to a parent of a toddler. The toddler frequently wants to drink different liquids, such as milk, orange juice, and water, at different times throughout the day. Thus, parents have to carry around several containers (e.g., spill-proof cups), each holding a different liquid. With the many other things that parents of toddlers have to carry when going out with the toddler, multiple containers are often an afterthought. When the parent and toddler are out, however, and the toddler wants a drink of juice, for instance, the parent is upset if the parent only has a container carrying milk. Alternatively, to satisfy the toddler's craving, the parent has to lug around several bottles at one time. Further, although the parent may be carrying several full bottles of different liquids around, the child may only drink a small amount of each.

Even at home, the problem of storing one liquid in a container is present. The parent typically has to have several filled containers in the refrigerator for the different requests of the toddler. Alternatively, the parent has to repeatedly wash and refill a single container with different liquids.

The designs that do enable the storage of more than one liquid at a time have several pitfalls. One pitfall is that containers storing more than one liquid at a time may leak a first liquid when dispensing a second liquid, thereby potentially mixing the liquids when one is being dispensed. A second concern is cost—the mechanisms (e.g., a valving structure) used to dispense the liquid are typically expensive. Additionally, some designs of containers capable of storing multiple liquids simultaneously are atypical.

A prior approach to solve these problems includes a container having a separate opening for each liquid to dispense each liquid. Although the separate opening enables a user to easily choose which liquid will be dispensed from the container, the separate opening still requires additional materials, thereby adding expense to the container. Further, the design of a container having multiple openings typically results in an abnormal or unusual look and feel of the container.

Another prior approach to solve the above mentioned problems is a container with a stopper to seal one section of the container while allowing liquid to pass through another section of the container. The user inserts the stopper into one section of the container to seal the section so that liquid does not leak through while the user dispenses the other liquid. Although the stopper may prevent an unusual look and feel of the container, the user has to go to great lengths to change the liquid that is being dispensed. For example, a user may have to pull the stopper out and then re-insert the stopper in a different position in order to change the liquid dispensed from the container opening. Further, if the user loses the stopper, the user can no longer control which liquid will be dispensed.

### SUMMARY

Thus, there remains a need to have an economical, compact design of a container that can store one or more liquids while enabling the user to easily change which liquid is dispensed by the container without mixing of the liquids.

In one aspect of the present invention, a container includes a first compartment storing a first liquid and a second compartment storing a second liquid. The container also includes an opening and a rotatable piece that includes a liquid release opening. The container additionally includes a control connected to the rotatable piece enabling the first liquid or the second liquid to be dispensed from the opening of the container by rotating the rotatable piece so that the liquid release opening aligns with one of the first compartment and the second compartment.

In one embodiment, the control includes a switch that moves the rotatable piece. The container can further include a slider that guides the switch. The first liquid and the second liquid may be the same liquid or may be different liquids. The container can also include a dispensing device connecting the liquid release opening with the opening of the container. In one embodiment, the container includes a container wall separating the two compartments. Further, the container can include a spill prevention plug associated with the opening of the container. In one embodiment, the spill prevention plug prevents the container opening from dispensing liquid unless a “sucking motion” is performed on the opening.

In another aspect, the invention includes a method for dispensing a liquid from a container having a control connected to a rotatable piece. The rotatable piece includes a liquid release opening. The method includes the steps of storing a first liquid in a first compartment of the container and storing a second liquid in a second compartment of the container. The method additionally includes rotating the rotatable piece via the control so that the liquid release opening aligns with either the first compartment or the second compartment to dispense either the first liquid or the second liquid.

In one embodiment, the method includes the step of connecting the liquid release opening with a container opening via a dispensing device. Further, the rotating step can include sliding the control along a control slider to align the liquid release opening with the first compartment or the second compartment.

### BRIEF DESCRIPTION OF THE DRAWINGS

FIG. 1 is a cross-sectional front view of an embodiment of a container having more than an one compartment that can store one or more liquids.

FIG. 2 is a cross-sectional front view of another embodiment of the container of FIG. 1.

FIG. 3 is a cross-sectional top view of an embodiment of the container of FIG. 1.

FIG. 4A is a view of a control and a control slider of the container of FIG. 1.

FIG. 4B is a more detailed view of the control of FIG. 4A.

FIG. 5 is a flow chart illustrating an embodiment of the steps performed to dispense liquid out of the container of FIG. 1.

### DETAILED DESCRIPTION

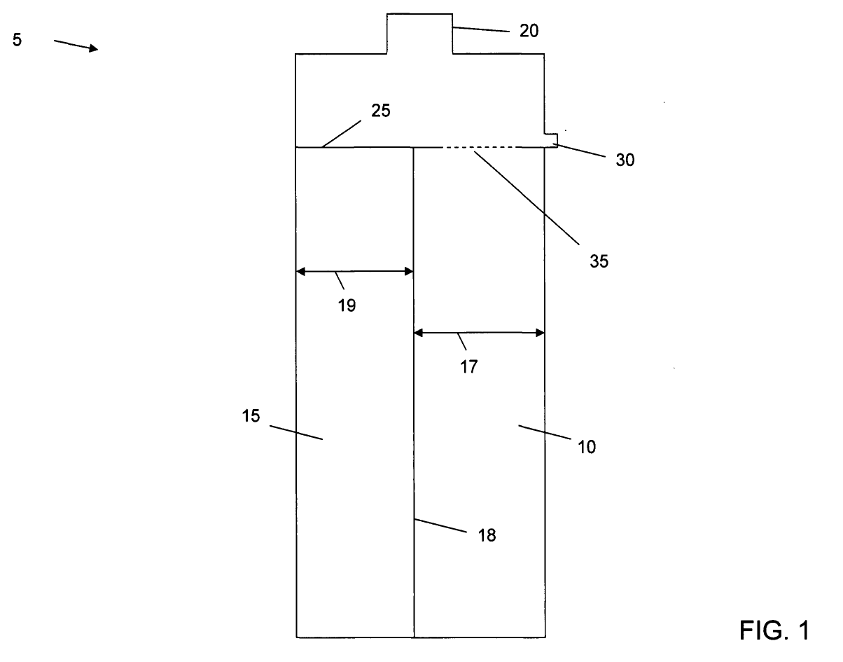

Referring to FIG. 1, an embodiment of a cross-sectional front view of a container 5 that can store one or more liquids is shown. The container 5 includes a first compartment 10 and a second compartment 15. The first compartment 10 stores a first liquid, such as milk, and the second compartment 15 stores a second liquid, such as water. The compartments 10, 15 are separated via a compartment wall 18. The first compartment 10 has a first width 17. The second compartment has a second width 19. The first width 17 and the second width 19 may be the same or may be different values. The container 5 also includes a single opening 20 that dispenses one of the two liquids from one of the two compartments 10, 15. The single opening 20 can be any shape or size. In one embodiment, the single opening is a spout.

The container 5 additionally includes a rotatable piece 25 that the user can rotate via a control 30 connected to the rotatable piece 25. The rotatable piece 25 includes a liquid release opening 35. In one embodiment, the liquid release opening 35 is rotated via the control 30. The liquid release opening 35 can be any shape or size as long as it enables liquid from one compartment 10, 15 to be dispensed without leakage from the other compartment 10, 15. In one embodiment, a larger liquid release opening 35 results in a larger amount of the first or second liquid to be dispensed out of the liquid release opening 35.

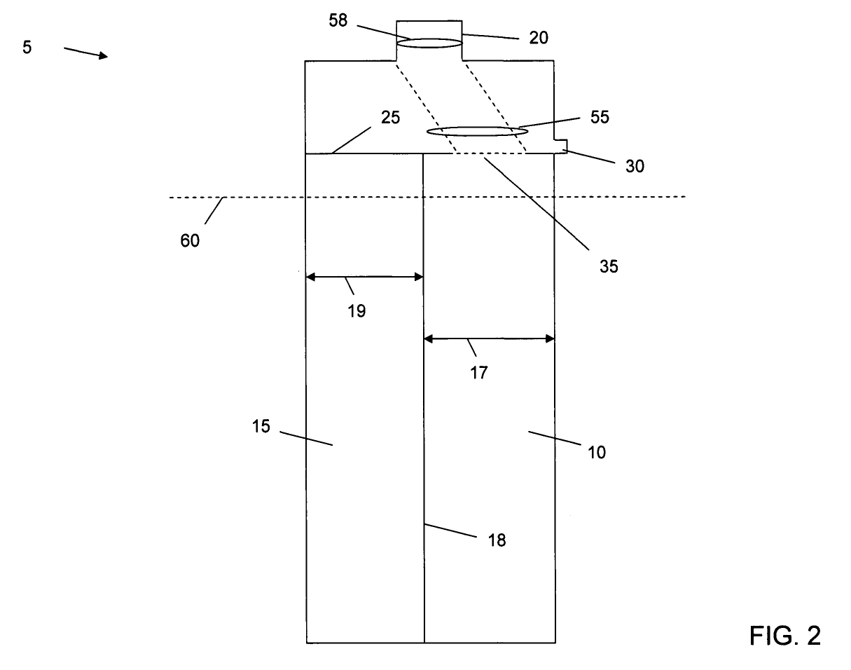

Referring to FIG. 2, another embodiment of a front view of the container 5 includes the liquid release opening 35 being connected to a dispensing device 55, such as a straw. The dispensing device 55 connects the liquid release opening 35 with the opening 20 (or spill prevention plug 58, as described in more detail below) of the container 5. In one embodiment, the control 30 includes the dispensing device 55.

The rotatable piece 25 moves when the user moves the control 30. The rotatable piece 25 and/or the control 30 can be manufactured out of any material so long as they do not interfere with the container 5 (e.g., result in too much friction between the rotatable piece 25 and the container 5). In one embodiment, the rotatable piece 25 and/or the container 5 are made out of plastic.

In one embodiment, the liquid release opening 35 has the same shape as one of the compartments 10, 15 or a portion of one of the compartments 10, 15. Thus, if the container 5 has two compartments 10, 15, then the liquid release opening 35 is either the size of one of the compartments 10, 15 (i.e., the first width 17 or the second width 19) or a portion of the widths 17, 19.

In one embodiment, the control 30 sits on a sliding track. The control 30 can be a switch (e.g., a slider). When a user moves the control 30 to a first position, the rotatable piece 25 rotates so that the liquid release opening 35 aligns with one compartment 10, 15. The liquid release opening 35 can also move one end of the dispensing device 55 as it rotates. Thus, the end of the dispensing device 55 attached to the liquid release opening 35 rotates with the rotatable piece 25.

In one embodiment, an upper portion 60 of the container 5 can be taken off of the rest of the container. For example, in a spill proof cup for toddlers (e.g., a Soft Starter® cup from Gerber Company of Parsippany, N.J.), the top of the container can be removed to pour the liquid into the container. According to the present invention, the top of the container 5 may be removable (e.g., unscrewable) in order to pour the liquids into the different compartments 10, 15.

The container 5 may also have a spill prevention plug 58. The spill prevention plug 58 can be a plug that plugs the opening 20 of the container 5 so that the user has to perform a sucking motion in order to dispense one of the liquids out of the opening 20. The spill prevention plug 58 may be removable so that it can, for instance, be easily cleaned. Alternatively, the spill prevention device 58 is fixed within the container 5. The spill prevention plug 58 may completely plug up the container opening so that no liquid can be removed unless the plug 58 is removed. Alternatively, a sucking motion is required in order to get liquid out of the opening, thereby preventing container spills.

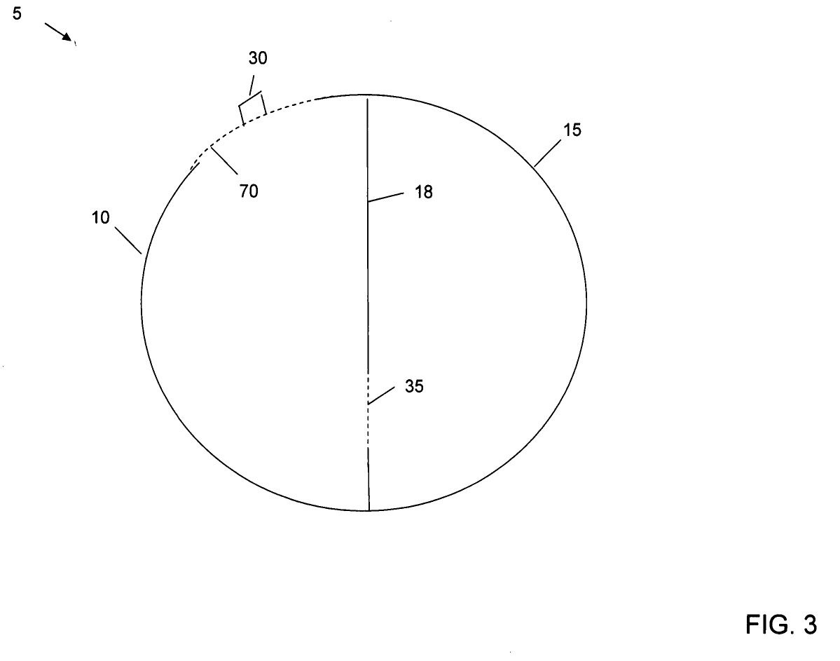

FIG. 3 is a cross-sectional top view of an embodiment of the container 5. The container 5 is circular and is divided into the first compartment 10 and the second compartment 15. Although shown with a circular shape, the container 5 may be any shape and size so long as at least two compartments can fit into the container. Moreover, the compartment wall 18 can be any shape and size.

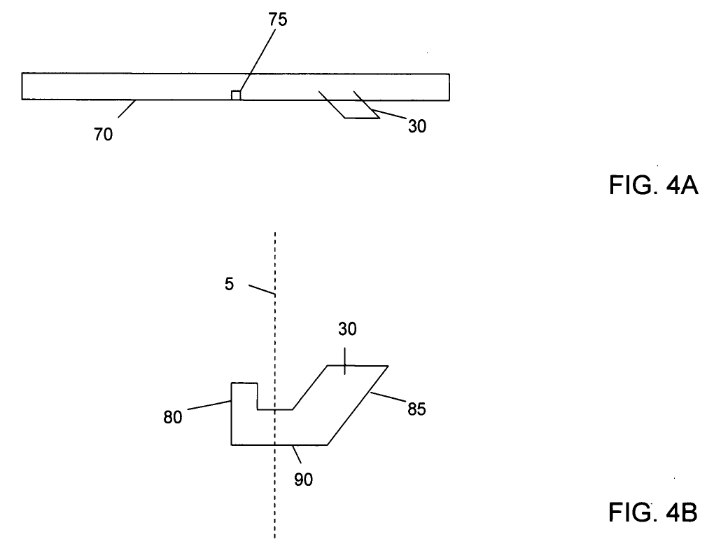

Also referring to FIG. 4A, a view of an embodiment of the control 30 and a control slider 70 is shown. The control slider 70 is an opening that the control 30 can move about. The control slider 70 is typically curved but can be any shape and size. It may be narrow or wide relative to the control 30. In one embodiment, the control slider 70 includes a groove 75 that stops the control 30. The groove 75 may stop the control 30 momentarily or may stop the control 30 for good until the user lifts the control 30 over the groove 75. In one embodiment, the groove 75 is used to stop the control 30 at the junction (e.g., the compartment wall 18) between the first compartment 10 and the second compartment 15. Although only shown with one groove 75, the control slider 70 may have any number of grooves 75 that may or may not correlate to the number of compartments.

FIG. 4B shows a more detailed view of the control 30. The control 30 can include an inner flange 80 and an outer flange 85 relative to the container 5. Thus, the inner flange 80 is on the inside of the container 5 and slides on the inside of the outer wall of the container 5. Outer flange 85 slides along the outside of container 5. The inner and outer flanges 80, 85 may be touching the container 5 or may be close to the container wall. The control 30 also has a base 90 that slides along the control slider 70.

An example of when the container 5 may be used is for a toddler. The toddler often wants milk, water, and orange juice at different times during one day. When the parent and child leave the home, the child's needs typically force the parent to carry several bottles or spill-proof cups/containers (e.g., Gerber's Soft Starter® cup from Gerber Company of Parsippany, N.J.), each with a different liquid.

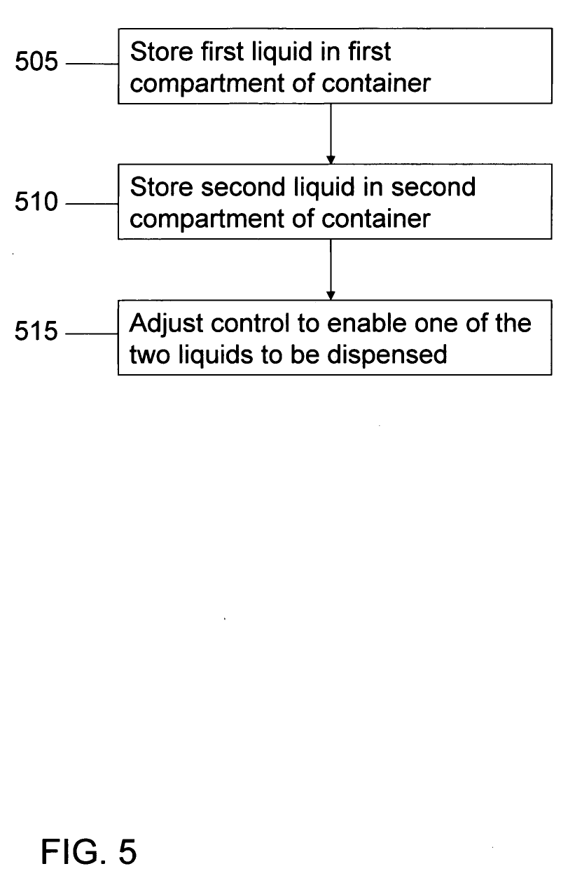

Also referring to FIG. 5 and according to the present invention, the parent can, instead of filling up and carrying different containers with different liquids, fill up the first compartment 10 of the container (step 505) with milk and the second compartment 15 with orange juice (step 510). Alternatively, the parent can fill up one of the compartments 10, 15 with water. Further, in yet another embodiment, the container 5 can have three compartments and the parent can fill up the container 5 with water, orange juice, and milk. If the toddler asks his or her parent for milk, the parent adjusts the control to rotate the rotatable piece 25 to dispense the milk from the corresponding compartment 10, 15 (step 515). Later, if the toddler wants orange juice, the parent can again adjust the rotatable piece 25 so that orange juice is dispensed.

Even at home, the container 5 offers convenience for the parent. The parent no longer has to store several containers in the refrigerator for the child, each having a different liquid. Instead, the parent can fill the container 5 with multiple liquids for the child's requests. The parent only has to refill a single container 5.

The present invention may also be applied to containers for athletes. During a workout, athletes may want to sometimes drink water and sometimes drink Gatoride. The container 5 can store both liquids, thereby enabling the athlete to enjoy both beverages at different times while only traveling with the container 5.

The foregoing description is to be understood as being in every respect illustrative and exemplary, but not restrictive, and the scope of the invention disclosed herein is not to be determined from the above description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A container comprising:
(a) a first compartment storing a first liquid;
(b) a second compartment storing a second liquid;
(c) an opening;
(d) a rotatable piece comprising a liquid release opening; and
(e) a control connected to the rotatable piece enabling one of the first liquid and the second liquid to be dispensed from the opening of the container by rotating the rotatable piece so that the liquid release opening aligns with one of the first compartment and the second compartment.

2. The container of claim 1 wherein the control further comprises a switch.

3. The container of claim 2 further comprising a slider that guides the switch.

4. The container of claim 1 wherein the first liquid is different than the second liquid.

5. The container of claim 1 wherein the first liquid is the same as the second liquid.

6. The container of claim 1 further comprising a dispensing device connecting the liquid release opening with the opening of the container.

7. The container of claim 1 further comprising a spill prevention plug associated with the opening of the container.

8. The container of claim 1 further comprising a removable upper portion.

9. A method for dispensing a liquid from a container comprising a control connected to a rotatable piece comprising a liquid release opening, the method comprising:
(a) storing a first liquid in a first compartment of the container;
(b) storing a second liquid in a second compartment of the container; and
(c) rotating the rotatable piece via the control so that the liquid release opening aligns with one of the first compartment and the second compartment to dispense one of the first liquid and the second liquid.

10. The method of claim 9 further comprising connecting the liquid release opening with a container opening via a dispensing device.

11. The method of claim 9 wherein the rotating step further comprises sliding the control along a control slider to align the liquid release opening with the one of the first compartment and the second compartment.

12. The method of claim 9 wherein the first liquid is the same as the second liquid.

13. The method of claim 9 further comprising preventing spilling of the first liquid and the second liquid via a spill prevention plug.

14. The method of claim 9 wherein the control further comprises a switch.

15. A container comprising a liquid release opening used to dispense a single liquid, the container comprising:
(a) means for storing a first liquid;
(b) means for storing a second liquid;
(c) means for aligning the liquid release opening with one of the means for storing the first liquid and the means for storing the second liquid to dispense one of the first liquid and the second liquid.

16. The container of claim 15 wherein the means for aligning the liquid release opening further comprises a switch.

17. The container of claim 16 wherein the means for aligning the liquid release further comprises means to slide the switch along a path to align the liquid release opening.

18. The container of claim 15 further comprising means to prevent spills of the first liquid and the second liquid.

19. The container of claim 15 further comprising means to dispense the one of the first liquid and the second liquid.

20. The container of claim 19 further comprising means to connect the liquid release opening with the means to dispense the one of the first liquid and the second liquid.
